(19) United States
(12) Patent Application Publication
(10) Pub. No.: US 2005/0114200 A1
(43) Pub. Date: May 26, 2005

(54) Systems and methods for instant lead generation and information capture

(75) Inventor: Gary Rivera, Torrance, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: creativdesign group, Inc., Torrance, CA (US)

(21) Appl. No.: 10/861,095

(22) Filed: Jun. 3, 2004

Related U.S. Application Data
(60) Provisional application No. 60/475,869, filed on Jun. 3, 2003.

(51) Int. Cl. G06F 17/60

(52) U.S. Cl. 705/10

(57) ABSTRACT

Systems and methods that utilize devices such as, for example, portable computers, laptop computers, tablet computers, notebook computers, personal digital assistants. computer terminals or kiosks to gather information from consumers and perspective customers at various events. The information gathered is transmitted in real time over a network to a central server. The central server processes the information and then transmits the processed information to various parties. The processed information is transmitted to a headquarters or a manufacturer, and is also transmitted to a reseller or dealer. Additionally, the processed information is used to create a follow-up response or responses to perspective customers. Such follow-up responses may include an electronic brochure, a product high-light video, a printable sales certificate, a thank you letter, and links/incentives to events similar to the event at which the information was gathered.

### CROSS-REFERENCES TO RELATED APPLICATIONS

This application claims priority to U.S. Provisional Application No. 60/475,869 (Attorney Docket No. 021864-000100US) filed Jun. 3, 2003, which is incorporated herein by reference for all purposes.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

1. Field of the Invention

The present invention relates to systems and methods for gathering consumer information and generating potential leads for sales, and more particularly, to systems and methods for real time information capture and generation of potential leads for sales.

2. Description of Prior Art

Manufacturers, wholesalers, retailers, dealers, etc. continually gather information about consumers and potential sales. Such information is important to manufacturers, wholesalers, retailers, dealers, etc. and helps facilitate communication with perspective customers before, during and even after a purchase.

In today's society, it is often critical that information concerning consumers and potential sales be received by prospective sellers or dealers as soon as possible in order to complete a deal. Delay in responding to a potential customer can often result in that customer going to another source in order to obtain desired goods and/or services. This can be especially true when a prospective customer is obtaining information from multiple sources about obtaining goods and/or services. If one delays in providing desired information to a prospective customer, the prospective customer, upon receiving information from a prospective dealer, may have already decided from where to obtain desired goods and/or services.

Thus, there is a real need for systems and methods for real time information capture and generation of potential leads for sales.

### BRIEF SUMMARY OF THE INVENTION

The present invention utilizes devices such as, for example, portable computers, laptop computers, tablet computers, notebook computers, personal digital assistants. computer terminals or kiosks to gather information from consumers and perspective customers at various events. The information gathered is transmitted in real time over a network to a central server. The central server processes the information and then transmits the processed information to various parties. Preferably, the processed information is transmitted to a headquarters or a manufacturer, and preferably is also transmitted to a reseller or dealer. Additionally, preferably the processed information is used to create a follow-up response or responses to perspective customers. Such follow-up responses may include an electronic brochure, a product high-light video, a printable sales certificate, a thank you letter, and links/incentives to events similar to the event at which the information was gathered.

Broadly, the present invention provides a method of generating potential sales leads and information relating to potential customers where the method includes gathering information from a potential customer electronically, transmitting the information over a network to a central server or servers, processing the gathered information and transmitting the processed information to at least one of a group comprising a manufacturer, a reseller or the potential customer.

In a broad sense, the present invention provides a system for generating potential sales leads and information relating to potential customers where the system includes at least one input device for gathering information for a potential customer electronically, a central server or servers for processing the gathered information, a communication conduit for transmitting the information to the central server or servers, and a secondary computing device for receiving the processed information transmitted over the communication conduit to at least one of a group comprising a manufacturer, a reseller or the potential customer.

In accordance with one aspect of the present invention, information relating to potential customers comprises at least one of a name, address, phone number, e-mail address, product in which a potential customer is interested, product a potential customer is currently using, other products a potential customer is currently considering, a time frame in which a potential customer is considering consummating a deal, request from a potential customer for further contact, and request for more information that could be received electronically or through the mail by a potential customer.

In accordance with another aspect of the present invention, the input device is coupled directly to the internet.

In accordance with a further aspect of the present invention, the input device accesses the internet via at least one of a group comprising an intermediate wireless radio connection, a wire, and another computer coupled to the internet.

In accordance with yet another aspect of the present invention, the method further includes gathered information being compared to a manufacturer's primary market area in order to insure a potential customer is directed to an appropriate dealership.

In accordance with a further aspect of the present invention, the method further comprises generating summary reports that include at least one of a group comprising lead reports, electronic brochure requests, regional distribution of leads gathered, and customized reports based upon manager's input.

In accordance with another aspect of the present invention, a further request for further information from a potential customer is forwarded to an appropriate dealership in a manner from a group comprising electronic mail, facsimile, and U.S. mail.

In accordance with a further aspect of the present invention, further information requested by the potential customer comprises at least one of a “thank you” electronic mail, an electronic brochure, printable coupons, a survey for customer feedback, streaming video or audio media selections, and links to other information that may be found on the internet.

Other features and advantages of the present invention will be apparent in view of the following detailed description of preferred exemplary embodiments.

### BRIEF DESCRIPTION OF THE DRAWINGS

FIG. 1 is a schematic that schematically illustrates a system in accordance with the present invention.

### DETAILED DESCRIPTION OF THE INVENTION

The following describes examples of features and parameters of an Instant Lead Generation/Capture System (Instant LeadGen). While the present invention will be described with reference to the automotive industry for simplicity, those skilled in the art will understand that the present invention may be used in numerous industries and scenarios.

The system is intended to be utilized by manufacturers, wholesalers, or retail organizations to gather information on their customers, and their interest/intention to purchase their goods. Such “leads” are important to manufacturers and resellers and facilitate communication with the prospect before, during, and after purchase.

The system may be characterized by at least three main processes:

1. Customer or prospect Information gathering/capture;

2. Database processing of prospect information; and

3. Output of prospect data and information.

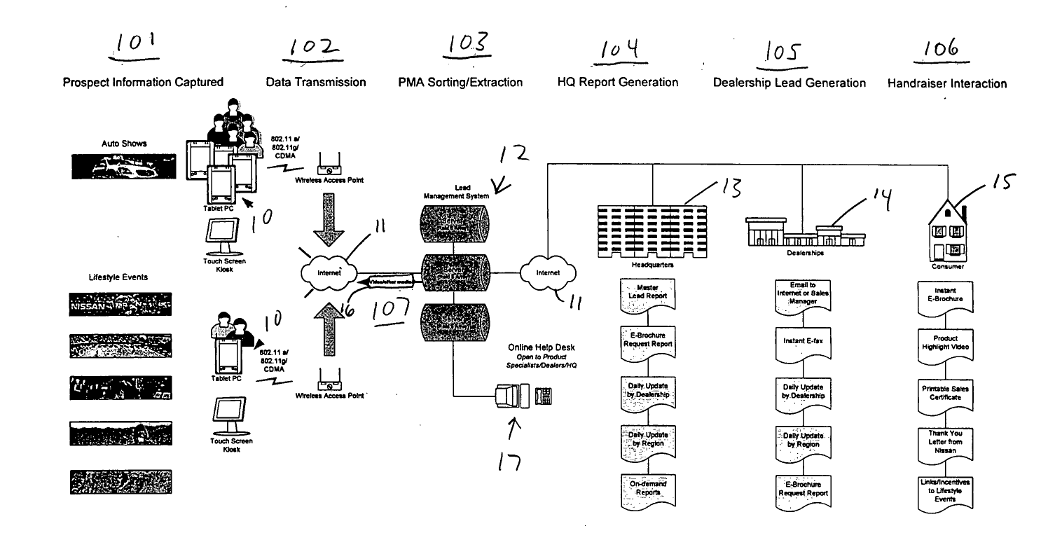

FIG. 1 further divides these processes into 7 general steps 101-107,—Prospect Information Captured, Data transmission, PMA Sorting/Extraction, HQ Report Generation, Dealership Lead Generation, Handraiser Interaction, and Video/media to Computers at Event.

Step 101 Prospect Information Captured

The prospect or potential customer is preferably engaged at a public event such as, for example, an auto show or a lifestyle event, through the use of an electronic input device 10, for example, a hand-held computer, Tablet PC or a touchscreen kiosk, by a specially- trained operator. Software on the computer, or on a computer server, generates a blank form on the screen, on which the operator, or the customer himself, fills in information by means of keyboard, touchscreen, or computer “stylus.” The Instant Lead Generation/Capture System collects information such as, for example,:

a. Prospect/customer name, address, phone numbers, email address;

b. Vehicle or product they are interested in purchasing;

c. Vehicle or product they are currently using;

d. Other vehicles or products they are currently considering;

e. The time frame that they are considering their lease or purchase;

f. Request for other contact, such as from a local dealership, or for a test drive; and

g. Request for information that they could receive electronically or through the mail.

From the moment the operator, or the prospect himself, enters their information or request, several “real time” events are set into motion.

Step 102 Data transmission

The input device is coupled either directly to a wide area network such as Internet 11 or accesses the Internet via, for example, an intermediate wireless radio connection, a wire, and/or via another computer coupled to the Internet. The data collected on the input device (hand held computer, or kiosk) is transmitted instantly through the Internet to a remotely-located computer server system 12.

Step 103 PMA Sorting/Extraction

Computer servers 12 receive the data for collection, parsing, and storage via Instant LeadGen software. Oftentimes, it is necessary to parse, or separate the data depending on the prospect's home address, phone number, or demographic information. In the case of the automotive industry, prospect data is preferably compared to the manufacturer's PMA (Primary Market Area) listing to ensure the prospect is directed to the appropriate auto dealership.

Once the data is parsed, or otherwise prepared, reports and other information are generated within the server and output over the Internet in preferably four different ways.

Step 104 HQ Report Generation

Prospect information data, summary reports, and detail reports are directed to the manufacturer's offices or headquarters (HQ) 13, or other location determined by the marketer. Such information, particularly “real-time” information as is the case with the present invention, is useful in determining the effectiveness of a marketing effort, or of the operators engaging the prospect.

Beyond the real-time information, the Instant LeadGen system also preferably generates summary reports at the end of the day, or after an event, providing valuable insights into a program's return-on-investment. Preferably the reports may be in text form, graphical form and/or browser based. “HQ” reports might include, for example,:

a. Lead reports, which provide the number of leads generated, for example, during a given time frame, region, and/or dealership, etc.;

b. Electronic brochure requests;

c. Regional distribution of leads gathered; and

d. Customized reports based upon management's input.

Step 105 Dealership Lead Generation

Prospects who have expressed an interest in being contacted by a local dealership have their contact information sent to the appropriate retailer/wholesaler 14 for follow-up. This data is sent to the dealership in a number of ways, depending on the customer's wishes, for example,:

a. Electronic mail (email);

b. Facsimile (fax or e-fax); and

c. US Mail.

Additionally, electronic reports are preferably generated by the Instant LeadGen system, and are delivered to the retail/wholesale organization's managers using the same methods. Such information provides desired “checks and balances” to ensure timely handling of the prospect's interest in the company's products.

Step 106 Handraiser Interaction

Potential consumers 15 in the form of “handraisers” often request additional information to be sent to them. With the Internet being available to most of the public, many wish to receive information electronically. Thus, the system may be configured to deliver virtually any type of communication, information, and media, instantly over the Internet. Examples of such include:

a. “Thank You” email;

b. “Electronic Brochure,” an Adobe “pdf” or other form of electronic media illustrating a company's product or service;

c. Printable coupons that may be taken to a dealer for money off, a gift, etc.;

d. Surveys, to facilitate customer feedback;

e. “Streaming” video or audio media selections; and

f. Links to other information that can be found on the Internet.

Step 107 Video/Media to Computers at Event

All media 16 that is available to a customer after the event is preferably available on-demand at the event, as well. Should a potential customer show interest in a given product, they may be offered the opportunity to view video or picture information on the same computer being utilized to collect data. To effect this, the Instant LeadGen system is preferably configured to send such media both to the originating point and to the customer after the event.

Preferably, an online help desk 17 is provided to provide assistance to various parties. The help desk is preferably reachable at least through the internet and/or telephone.

Preferably, the system uses ASP (Active Server Pages) for its programming. Those skilled in the art will understand that other technologies may be utilized.

Thus, the Instant Lead Generation/Capture system in accordance with the present invention provides a manufacturer a channel for personalized, “opt-in,” end-to-end customer contact.

Thus, the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method of generating potential sales leads and information relating to potential customers, the method comprising:
gathering information from a potential customer electronically;
transmitting the information over a network to a central server or servers;
processing the gathered information; and
transmitting the processed information to at least one of a group comprising a manufacturer, a reseller or the potential customer.

2. A method in accordance with claim 1 wherein information relating to potential customers comprises at least one of a name, address, phone number, e-mail address, product in which a potential customer is interested, product a potential customer is currently using, other products a potential customer is currently considering, a time frame in which a potential customer is considering consummating a deal, request from a potential customer for further contact, and request for more information that could be received electronically or through the mail by a potential customer.

3. A method in accordance with claim 1 wherein the method further includes gathered information being compared to a manufacturer's primary market area in order to insure a potential customer is directed to an appropriate dealership.

4. A method in accordance with claim 1 wherein the method further comprises generating summary reports that include at least one of a group comprising lead reports, electronic brochure requests, regional distribution of leads gathered, and customized reports based upon manager's input.

5. A method in accordance with claim 1 wherein a further request for further information from the potential customer is forwarded to an appropriate dealership in a manner from a group comprising electronic mail, facsimile, and U.S. mail.

6. A method in accordance with claim 5 wherein further information requested by the potential customer comprises at least one of a “thank you” electronic mail, an electronic brochure, printable coupons, a survey for customer feedback, streaming video or audio media selections, and links to other information that may be found on the internet.

7. A system for generating potential sales leads and information relating to potential customers, the system comprising:
at least one input device for gathering information from a potential customer electronically;
a central server or servers for processing the gathered information;
a communication conduit for transmitting the information to the central server or servers; and
a secondary computing device for receiving the processed information transmitted over the communication conduit to at least one of a group comprising a manufacturer, a reseller or the potential customer.

8. A system in accordance with claim 7 wherein the input device is coupled directly to the internet.

9. A system in accordance with claim 7 wherein the input device accesses the internet via at least one of a group comprising an intermediate wireless radio connection, a wire, and another computer coupled to the internet.

10. A method of generating potential sales leads and information relating to potential customers, the method comprising:
gathering information from a potential customer electronically;
transmitting the information over a network to a central server or servers;
processing the gathered information;
transmitting the processed information to at least one of a group comprising a manufacturer, a reseller or the potential customer;
comparing gathered information to a manufacturer's primary market area in order to insure a potential customer is directed to an appropriate dealership; and
generating summary reports that include at least one of a group comprising lead reports, electronic brochure requests, regional distribution of leads gathered, and customized reports based upon manager's input;
wherein information relating to potential customers comprises at least one of a name, address, phone number, e-mail address, product in which a potential customer is interested, product a potential customer is currently using, other products a potential customer is currently considering, a time frame in which a potential customer is considering consummating a deal, request from a potential customer for further contact, and request for more information that could be received electronically or through the mail by a potential customer.
